(19) United States
(12) Patent Application Publication
(10) Pub. No.: US 2024/0163867 A1
(43) Pub. Date: May 16, 2024

(54) CHANNEL OCCUPANCY TIME SHARING INFORMATION

(71) Applicant: Lenovo (Singapore) Pte. Ltd., New Tech Park (SG)

(72) Inventors: Hossein Bagheri, Urbana, IL (US); Vijay Nangia, Woodridge, IL (US); Hyejung Jung, Northbrook, IL (US); Ankit Bhamri, Rödermark (DE); Joachim Löhr, Wiesbaden (DE); Alexander Johann Maria Golitschek Edler von Elbwart, Darmstadt (DE); Ravi Kuchibhotla, Chicago, IL (US); Seyedomid Taghizadeh Motlagh, Oberursel (DE)

(21) Appl. No.: 18/549,149

(22) PCT Filed: Mar. 7, 2022
(86) PCT No.: PCT/IB2022/052013

§ 371 Date: Sep. 5, 2023

Related U.S. Application Data
(60) Provisional application No. 63/157,572, filed on Mar. 5, 2021.

(51) Int. Cl. H04W 72/1263; H04W 74/0816

(52) U.S. Cl. CPC H04W 72/1263; H04W 74/0816

(57) ABSTRACT

Apparatuses, methods, and systems are disclosed for full duplex operation in unlicensed spectrum. One method includes receives UCI containing first COT sharing information and second COT sharing information. The first COT sharing information includes a first duration and a first offset from the end of a slot where the UCI is detected. The second COT sharing information includes a second duration different than the first duration. The method includes transmitting a first set of DL transmissions to a first set of UEs for the duration of the first duration and transmitting a second set of DL transmissions to a second set of UEs for the duration of the second duration, where the first set of DL transmissions occurs after the first offset and where the first UE belongs to the first set of UEs.

### CROSS-REFERENCE TO RELATED APPLICATIONS

This application claims priority to U.S. Provisional Patent Application No. 63/157,572 entitled “FULL DUPLEX OPERATION IN UNLICENSED SPECTRUM” and filed on 5 Mar. 2021 for Hossein Bagheri, Vijay Nangia, Hyejung Jung, Ankit Bhamri, Joachim Lohr, Alexander Golitschek, Ravi Kuchibhotla, Seyedomid Taghizadeh Motlagh, which application is incorporated herein by reference.

### FIELD

The subject matter disclosed herein relates generally to wireless communications and more particularly relates to full duplex operation in unlicensed spectrum.

### BACKGROUND

For Third Generation Partnership Project (“3GPP”) New Radio (“NR”, i.e., 5^{th} generation Radio Access Technology (“RAT”)), time-division duplexing (“TDD”) may be used in unpaired spectrum to avoid interference (e.g., UL and/or DL interference within a network entity and UE-to-UE interference). However, TDD limits UL and DL transmission opportunities and prevents accommodating urgent UL and DL transmissions simultaneously.

For operation in unlicensed spectrum, especially in a semi-static channel access (operation according to Frame-Based Equipment (“FBE”)), downlink and uplink transmissions are allowed after a node such as a gNB or a UE has acquired the shared channel by a successful clear channel assessment, following a listen-before-talk (“LBT”) procedure.

### BRIEF SUMMARY

Disclosed are procedures for full duplex operation in unlicensed spectrum. Said procedures may be implemented by apparatus, systems, methods, or computer program products.

One method at a Radio Access Network (“RAN”) for full duplex operation in unlicensed spectrum includes receiving an Uplink Control Information (“UCI”) from a first User Equipment (“UE”), the UCI containing first Channel Occupancy Time (“COT”) sharing information and second COT sharing information. Here, the first COT sharing information includes a first duration and a first offset from the end of a slot where the UCI is detected. The second COT sharing information includes a second duration, where the first duration and the second durations are different. The first method includes transmitting a first set of downlink (“DL”) transmissions to a first set of UEs for the duration of the first duration and transmitting a second set of DL transmissions to a second set of UEs for the duration of the second duration. Here, the first UE belongs to the first set of UEs, and the first set of DL transmissions occurs after the first offset.

One method at a UE for full duplex operation in unlicensed spectrum includes receiving COT sharing information from a RAN node, where the COT sharing information indicates that the RAN node is operating in full-duplex mode during a RAN-initiated COT. The method includes determining whether the UE is permitted to transmit during the RAN-initiated COT and transmitting a first set of uplink transmissions within the RAN-initiated COT in response to determining that the UE is permitted to transmit during the RAN-initiated COT.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for full duplex operation in unlicensed spectrum;

FIG. 2 is a diagram illustrating one embodiment of a Third Generation Partnership Project (“3GPP”) New Radio (“NR”) protocol stack;

FIG. 3 is a diagram illustrating one embodiment of a Fixed Frame Period structure for operation in shared spectrum;

FIG. 4 is a diagram illustrating one embodiment of a RAN that supports full duplex operation in unlicensed spectrum;

FIG. 5 is a diagram illustrating one embodiment of a procedure for sharing a UE-initiated COT with a full duplex RAN node during full duplex operation in unlicensed spectrum;

FIG. 6A is a diagram illustrating a first embodiment of a UE-initiated COT that may be shared during full duplex operation in unlicensed spectrum;

FIG. 6B is a diagram illustrating a second embodiment of a UE-initiated COT that may be shared during full duplex operation in unlicensed spectrum;

FIG. 6C is a diagram illustrating a third embodiment of a UE-initiated COT that may be shared during full duplex operation in unlicensed spectrum;

FIG. 7 is a diagram illustrating one embodiment of a procedure for sharing a gNB-initiated COT with a UE during full duplex operation in unlicensed spectrum;

FIG. 8 is a diagram illustrating a radio frame in unlicensed communication;

FIG. 9 is a block diagram illustrating one embodiment of a user equipment apparatus that may be used for full duplex operation in unlicensed spectrum;

FIG. 10 is a block diagram illustrating one embodiment of a network apparatus that may be used for full duplex operation in unlicensed spectrum;

FIG. 11 is a flowchart diagram illustrating one embodiment of a first method for full duplex operation in unlicensed spectrum; and

FIG. 12 is a flowchart diagram illustrating one embodiment of a second method for full duplex operation in unlicensed spectrum.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of′ includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for flexible uplink (“UL”) and downlink (“DL”) communications with full duplex operation, e.g., performing an UL transmission in a DL portion of a slot and/or performing DL transmission in an UL portion of a slot. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Generally, the present disclosure describes systems, methods, and apparatuses for full duplex operation in unlicensed spectrum. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Full duplex operation at a serving gNB could allow gNB to receive UL transmissions from a first set of UEs and transmit DL transmissions to a second set of UEs at the same time. Such an operation could bring gains/enhancements in terms of increasing spectral efficiency and/or reducing latency compared to a half-duplex gNB.

For operation in unlicensed spectrum, especially in a semi-static channel access (operation according to Frame-Based Equipment), downlink and uplink transmissions are allowed after a node such as a gNB or a UE has acquired the shared channel by a successful clear channel assessment, following a listen-before-talk (“LBT”) procedure. The procedures for gNBs and UEs acquiring a channel occupancy time (“COT”) have been specified in 3GPP NR Release 16 (“Rel-16”) for both dynamic and semi-static channel access, except for UEs initiating a COT for semi-static channel access which is being specified in 3GPP NR Release 17 (“Rel-17”).

To realize the FD gains, the gNB that is receiving an UL transmission from a first UE should be able to transmit a DL transmission to a second UE. To enable such an operation, following changes to the channel access procedure is required: 1) The gNB can start the DL transmission without sensing while still receiving the UL transmission; 2) The gNB sharing the COT initiated by the first UE needs to perform LBT procedure prior to the DL transmission (e.g., if there is a gap larger than 16 microsecond (“μs”) from the previous (UL or DL) transmission burst). The gNB must determine whether the medium is at most occupied by the first UE instead of determining the medium is free as done in Rel-16/17. For achieving FD gains, the DL transmission to the second UE should not be delayed due to sensed UL transmission from the first UE.

This disclosure provides mechanisms to enable simultaneous transmissions of a first UE's UL transmission and gNB's DL transmission to a second UE in a COT.

For unpaired spectrum operation for a UE on a cell in a frequency band of Frequency Range #1 (“FR1”, i.e., referring to radio frequencies between 410 MHz to 7.125 GHz), and when the scheduling restrictions due to Radio Resource Management (“RRM”) measurements (e.g., 3GPP Technical Specification (“TS”) 38.133) are not applicable, if the UE detects a Downlink Control Information (“DCI”) format indicating to the UE to transmit in a set of symbols, the UE is not required to perform RRM measurements (e.g., 3GPP TS 38.133) based on a Synchronization Signal/Physical Broadcast Channel (“SS/PBCH”) block or Channel State Information Reference Signal (“CSI-RS”) reception on a different cell in the frequency band if the SS/PBCH block or CSI-RS reception includes at least one symbol from the set of symbols.

Disclosed are solutions for full duplex operation in unlicensed spectrum. The solutions may be implemented by apparatus, systems, methods, or computer program products. The disclosure presents solutions to enable simultaneous transmissions of a first UE's uplink (“UL”) transmission to a gNB and the gNB's downlink (“DL”) transmission to a second UE in a Channel Occupancy Time (“COT”).

In certain embodiments, a configured grant uplink control information (“CG-UCI”) contains two sets of COT sharing information: one applicable to gNB-DL transmissions for which full duplex (“FD”) is possible; and one applicable to gNB-DL transmissions for which FD is not possible. As used herein, the notation “gNB-DL transmission” refers to a DL transmission by a gNB.

In certain embodiments, LBT is enhanced at the gNB side. In one embodiment, LBT may be not required while gNB is receiving UL transmissions from a UE. In another embodiment, the gNB determines if the medium is occupied by at most first UE (according to omni-directional sensing or according to sensing a particular direction in directional sensing).

In certain embodiments, the gNB indicates if a gNB-initiated COT (“gNB-COT”) is a full-duplex COT (“FD-COT”) or not. In certain embodiments, idle-mode UEs are not allowed to perform random-access procedure (i.e., RACH procedure) during an FD-gNB-COT. As used herein, the notation “FD-gNB” refers to a gNB capable of full duplex operation, and the notation “FD-gNB-COT” refers to a COT initiated by a gNB operating in full-duplex mode, while the notation “non-FD-gNB-COT” refers to a COT initiated by a gNB not operating in full-duplex mode (e.g., for the duration of the COT).

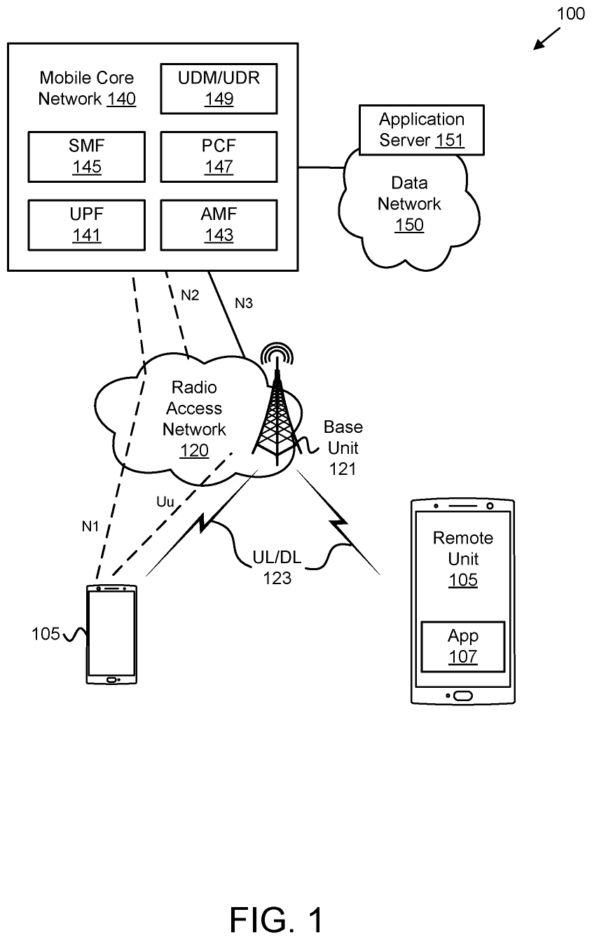

FIG. 1 depicts a wireless communication system 100 for full duplex operation in unlicensed spectrum, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for full duplex operation in unlicensed spectrum apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for full duplex operation in unlicensed spectrum.

It should be understood that this disclosure uses the terms Channel State Information Reference Signal Resource Index (“CRI”), and Synchronization Signal/Physical Broadcast Channel Block Resource Index (“SSBRI”), and beam are used interchangeably. interchangeably.

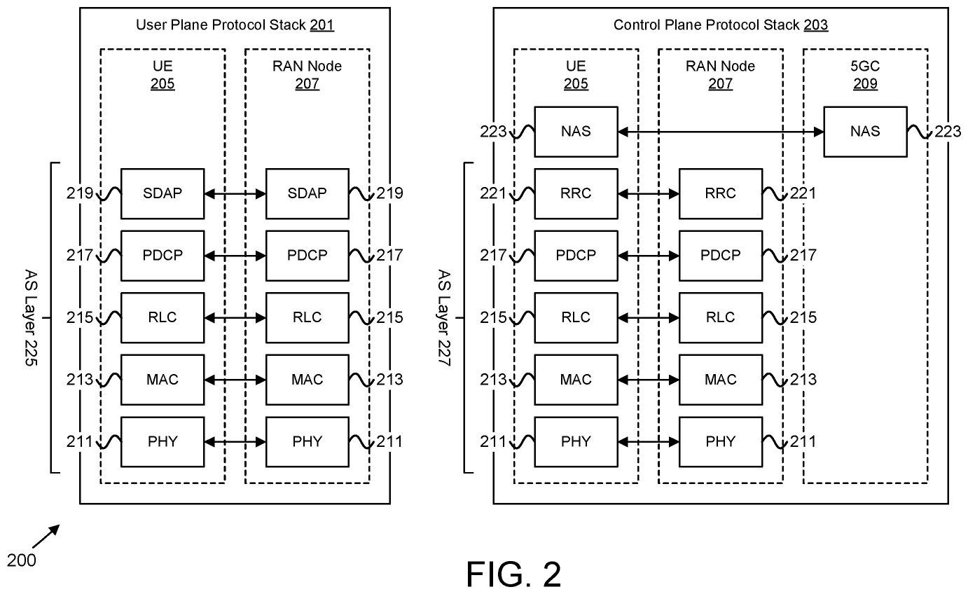

FIG. 2 depicts a NR protocol stack 200, according to embodiments of the disclosure. While FIG. 2 shows a UE 205, a RAN node 207 and the 5G core network 209, these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 211, a Medium Access Control (“MAC”) sublayer 213, a Radio Link Control (“RLC”) sublayer 215, a Packet Data Convergence Protocol (“PDCP”) sublayer 217, and Service Data Adaptation Protocol (“SDAP”) layer 219. The Control Plane protocol stack 203 includes a physical layer 211, a MAC sublayer 213, a RLC sublayer 215, and a PDCP sublayer 217. The Control Place protocol stack 203 also includes a Radio Resource Control (“RRC”) layer 221 and a Non-Access Stratum (“NAS”) layer 223.

The AS layer 225 (also referred to as “AS protocol stack”) for the User Plane protocol stack 201 consists of at least SDAP, PDCP, RLC and MAC sublayers, and the physical layer. The AS layer 227 for the Control Plane protocol stack 203 consists of at least RRC, PDCP, RLC and MAC sublayers, and the physical layer. The Layer-1 (“L1”) contains the PHY layer 211. The Layer-2 (“L2”) is split into the SDAP, PDCP, RLC and MAC sublayers. The Layer-3 (“L3”) includes the RRC sublayer 221 and the NAS layer 223 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The physical layer 211 offers transport channels to the MAC sublayer 213. The MAC sublayer 213 offers logical channels to the RLC sublayer 215. The RLC sublayer 215 offers RLC channels to the PDCP sublayer 217. The PDCP sublayer 217 offers radio bearers to the SDAP sublayer 219 and/or RRC layer 221. The SDAP sublayer 219 offers QoS flows to the core network (e.g., 5GC). The RRC layer 221 provides for the addition, modification, and release of Carrier Aggregation (“CA”) and/or Dual Connectivity (“DC”). The RRC layer 221 also manages the establishment, configuration, maintenance, and release of Signaling Radio Bearers (“SRBs”) and Data Radio Bearers (“DRBs”).

The MAC layer 213 is the lowest sublayer in the Layer-2 architecture of the NR protocol stack. Its connection to the PHY layer 211 below is through transport channels, and the connection to the RLC layer 215 above is through logical channels. The MAC layer 213 therefore performs multiplexing and demultiplexing between logical channels and transport channels: the MAC layer 213 in the transmitting side constructs MAC PDUs, known as transport blocks, from MAC Service Data Units (“SDUs”) received through logical channels, and the MAC layer 213 in the receiving side recovers MAC SDUs from MAC PDUs received through transport channels.

The MAC layer 213 provides a data transfer service for the RLC layer 215 through logical channels, which are either control logical channels which carry control data (e.g., RRC signaling) or traffic logical channels which carry user plane data. On the other hand, the data from the MAC layer 213 is exchanged with the physical layer through transport channels, which are classified as downlink or uplink. Data is multiplexed into transport channels depending on how it is transmitted over the air.

The PHY layer 211 is responsible for the actual transmission of data and control information via the air interface, i.e., the PHY Layer 211 carries all information from the MAC transport channels over the air interface on the transmission side. Some of the important functions performed by the PHY layer 211 include coding and modulation, link adaptation (e.g., Adaptive Modulation and Coding (“AMC”)), power control, cell search (for initial synchronization and handover purposes) and other measurements (inside the 3GPP system (i.e., NR and/or LTE system) and between systems) for the RRC layer 221. The PHY layer 211 performs transmissions based on transmission parameters, such as the modulation scheme, the coding rate (i.e., the modulation and coding scheme (“MCS”)), the number of physical resource blocks etc.

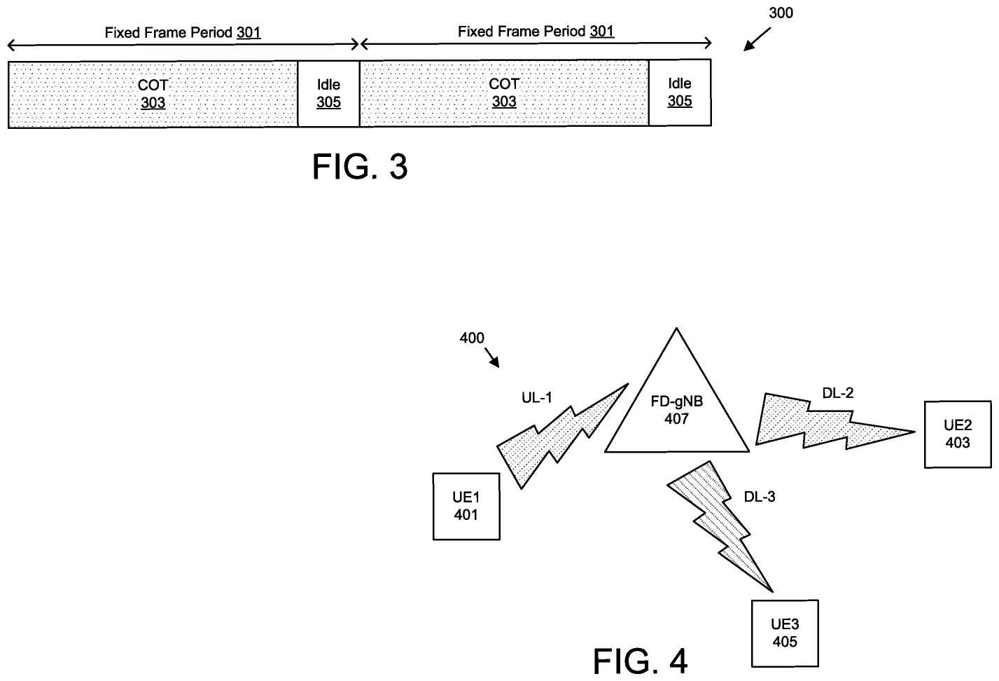

FIG. 3 depicts one embodiment of a Fixed Frame Period structure 300. A Fixed Frame Period 301 is comprised of a Channel Occupancy Time (“COT”) 303 and an idle period 305. Following the idle period, another COT 303 begins and is also followed by an idle period 305, etc.

In Frame Based Equipment (“FBE”) mode of operation, the UE or gNB performs LBT in an idle period 305 and once acquired the channel/medium, the UE or gNB can communicate within the non-idle time of a fixed frame period duration (referred to as the Channel Occupancy Time (“COT”) 303). In current specifications/regulations, the idle period 305 is not to be shorter than the maximum of: 5% of the FFP 301, and 100 microseconds (“μs”).

Regarding unlicensed/shared spectrum technology, the following terminologies are defined:

A “channel” refers to a carrier or a part of a carrier consisting of a contiguous set of resource blocks (“RBs”) on which a channel access procedure is performed in shared spectrum.

A “channel access procedure” refers to a sensing-based procedure that evaluates the availability of a channel for performing transmissions. The basic unit for sensing is a sensing slot with a duration Tₛₗ=9 μs. The sensing slot duration Tₛₗ is considered to be idle if an eNB/gNB or a UE senses the channel during the sensing slot duration, and determines that the detected power for at least 4 μs within the sensing slot duration is less than energy detection threshold X_{Thresh}. Otherwise, the sensing slot duration Tₛₗ is considered to be busy.

A “channel occupancy” refers to transmission(s) on channel(s) by eNB(s)/gNB(s) or UE(s) after performing the corresponding channel access procedures, e.g., as described in 3GPP TS 37.213.

A “Channel Occupancy Time” refers to the total time for which the initiating eNB/gNB or UE and any eNB(s)/gNB(s) or UE(s) sharing the channel occupancy perform transmission(s) on a channel, i.e., after an eNB/gNB or UE performs the corresponding channel access procedures described in this clause. For determining a Channel Occupancy Time, if a transmission gap is less than or equal to 25 μs, the gap duration is counted in the channel occupancy time. A channel occupancy time can be shared for transmission between an eNB/gNB and the corresponding UE(s).

A “DL transmission burst” is defined as a set of transmissions from an eNB/gNB without any gaps greater than 16 μs. Transmissions from an eNB/gNB separated by a gap of more than 16 μs are considered as separate DL transmission bursts. An eNB/gNB may transmit transmission(s) after a gap within a DL transmission burst without sensing the corresponding channel(s) for availability.

A “UL transmission burst” is defined as a set of transmissions from a UE without any gaps greater than 16 μs. Transmissions from the same UE which are separated by a gap of more than 16 μs are considered as separate UL transmission bursts. A UE may transmit subsequent transmission(s) after a gap within a UL transmission burst without sensing the corresponding channel(s) for availability.

A UE may perform channel sensing and access the channel if it senses the channel to be idle. A UE-initiated COT may be especially useful in low-latency applications, wherein the UE having UL data to be sent in configured grant resources is allowed to initiate a COT. Sometimes, it is useful to share the acquired COT with the gNB, such that gNB could schedule DL or UL for the same UE or for other UEs.

Regarding channel access procedure, two high-level LBT mechanisms are described: a) omni-directional LBT; and b) directional LBT. Omni-directional LBT (or quasi-omni-directional LBT) is the Rel-16 LBT procedure in which the LBT measurements are not performed over a (set of) particular/narrow beam(s) in which the intended transmissions are to be performed. In contrast, for directional LBT, the LBT measurements are performed over a (set of) narrow/particular beam(s) over which the intended transmissions are to be performed.

Regarding UE-initiated channel occupancy (“CO”), a UE can perform channel sensing and access the channel if it senses the channel to be idle. A UE-initiated CO has not been specified in Rel-16 for FBE (semi-static channel access). However, it is expected to be specified in 3GPP Rel-17. UE-initiated CO could be useful especially in low-latency applications, wherein having UL data to be sent in configured grant resources is allowed to initiate a CO.

It should be noted that throughout the disclosure, the terms “symbol,” “slot,” “subslot,” or “Transmission Time Interval” (abbreviated “TTI”) are used to refer to a time unit with a particular duration (e.g., symbol could be a fraction/percentage of an Orthogonal Frequency Division Multiplexing (“OFDM”) symbol length associated with a particular subcarrier spacing (“SCS”)). In the following, an UL transmission (e.g., a UL transmission burst, as defined above) can be comprised of multiple transmissions (e.g., of the same/different priority in case a priority is associated with the transmissions) with gaps between the transmissions, wherein the gaps are short enough in duration to not necessitate performing a channel sensing operation (e.g., LBT operation) between the transmissions.

In the following, an UL transmission can contain a PUSCH, a PUCCH, Physical Random Access Channel (“PRACH”), or an UL signal such as sounding reference signal. In the following, an UL transmission can contain Uplink Control Information (“UCI”) such as a configured grant UCI (“CG-UCI”). Note that CG-UCI may contain information regarding the acquired COT such as COT sharing information. Alternatively, the UL transmission can contain a Scheduling Request (“SR”) or periodic Channel State Information (“CSI”) or semi-persistent CSI.

Throughout the disclosure, sometimes the terms “CO” and “COT” are used interchangeably. It should be noted that in a more general sense, the main intention of the embodiments and implementations in the disclosure relates to transmissions by a UE, so the various embodiments and implementations can also be applied to sidelink (“SL”) transmissions rather than UL transmissions by a UE, where a SL transmission can contain Physical Sidelink Broadcast Channel (“PSBCH”), Physical Sidelink Control Channel (“PSCCH”), Physical Sidelink Shared Channel (“PSSCH”), Physical Sidelink Feedback Channel (“PSFCH”) or other SL transmissions as described in 3GPP TS 38.211 v16.4.0.

In the following embodiments and implementations, sharing a COT implies that the device or node with which the COT is shared can forego an indicated or configured channel access category/type and instead apply/perform a channel access according to a category/type whose characteristic includes a generally shorter sensing period, an increased likelihood for the channel sensing to result in being able to transmit, or no required sensing period prior to transmission in the shared COT.

FIG. 4 depicts an example implementation of a RAN 400 that supports full duplex operation in unlicensed spectrum, according to embodiments of the disclosure. The RAN 400 serves a plurality of UEs, including a first UE (depicted “UE1”) 401, a second UE (depicted “UE2”) 403 and a third UE (depicted “UE3”) 405. The UEs communicate with a FD-gNB 407. In the depicted implementation, it is assumed that the first UE 401 and the third UE 405 belong to one set of UEs, while the second UE 403 belongs to a different set of UEs. The FD-gNB 407 can simultaneously transmit DL signals to the second set of UEs (i.e., containing the second UE 403) while receiving UL transmission from the first UE 401. However, the FD-gNB 407 does not transmit DL signals to the first group of UEs (i.e., containing the first UE 401 and the third UE 405) while the first UE 401 is performing UL transmission.

For the first solution, it is assumed that a first UE 401 initiates a COT, wherein a FD-gNB 407 may share the UE-initiated COT. Prior to initiating the COT, the first UE 401 applies a LBT procedure to verify that the channel is idle and can be used. At the start of the COT, the first UE 401 uses a first part of the COT, e.g., for one or more UL transmissions, after which a remaining portion of the COT is available to be shared, e.g., with the FD-gNB 407 and/or with other UEs in the RAN. Moreover, the FD-gNB 407 may transmit one or more DL transmissions to another UE (e.g., the second UE 403), while concurrently receiving the UL transmission(s) from the first UE 401, as mentioned above, and described in greater detail below. Moreover, the first UE 401 may transmit COT sharing information (e.g., at a beginning portion of the UE-initiated COT) to coordinate the sharing of the UE-initiated COT. A nominal end of the COT is determined from the start of the UE-initiated COT and determines the end of the UE-initiated COT. The nominal end should be understood as the instance of the latest allowed transmission within a CO.

The nominal end can be determined by a maximum duration of the channel occupancy. The maximum duration of the channel occupancy may be equivalent to or upper-bounded by a pre-defined value, e.g., by a maximum channel occupancy time (“MCOT”), or can be determined from an explicit indication, e.g., from a remaining COT duration indication. For example, if the MCOT is defined or determined as 8 time units, then the nominal end of the acquired channel occupancy is 8 time units after acquiring the channel occupancy.

Regarding applicability of COT sharing information, according to embodiments of the first solution, the first UE 401 sends an Uplink Control Information (“UCI”) (e.g., CG-UCI) indicating COT sharing information, including a duration of DL transmission slots (i.e., a first duration) and an offset from the end of the slot where the UCI is detected (i.e., a first offset). After waiting until the time indicated by the (first) offset, the FD-gNB 407 can share the COT.

The FD-gNB 407 is able to send a DL transmission to a second UE 403 prior to the time indicated by the (first) offset if the second UE 403 belongs to a second set of UEs. Here, the COT sharing information UCI is not applicable to DL transmissions associated with the second set of UEs. In one embodiment, the second set of UEs comprises a set of one or more UEs that are located within the RAN where directional (i.e., beam-based) communication to the second set of UEs does not create interference with UL transmissions from the first UE 401. Similarly, the first group of UEs (i.e., containing the first UE 401) may be defined such that communication with the first set of UEs would create interference with UL transmissions from the first UE 401.

The FD-gNB 407 sends a DL transmission to a third UE 405 after the (first) offset within the indicated duration if the third UE 405 belongs to the first set of UEs, where the third UE 405 does not belong to the second set of UEs, and where the first UE 401 and third UE 405 belong to the first set of UEs. Here, the COT sharing information in UCI is applicable to DL transmissions associated with the first set of UEs.

In certain embodiments of the first solution, the first UE 401 may include in the UCI an indication that the first UE 401 does not want the FD-gNB 407 to send DL transmissions to second set of UEs prior to the time indicated by the (first) offset. Accordingly, upon receiving such an indication, the FD-gNB 407 can only send DL transmissions after the (first) offset and during the indicated (first) duration. In an embodiment, the first UE 401 indicates in the UCI whether the second set is an empty set, where an indication of an empty set is an indication that full-duplex sharing of the COT during the UL transmission of the first UE 401 is not allowed.

In an example, if the first UE 401 has an UL transmission that is a critical signal—or another transmission with high reliability requirement—to be transmitted within the first UE's initiated COT (e.g., a transmission in the UE-initiated COT in a configured UL transmission), then the first UE 401 may not want to risk that concurrent DL transmissions at the FD-gNB 407 impact the UL reception at the FD-gNB 407 for the first UE's upcoming UL transmission.

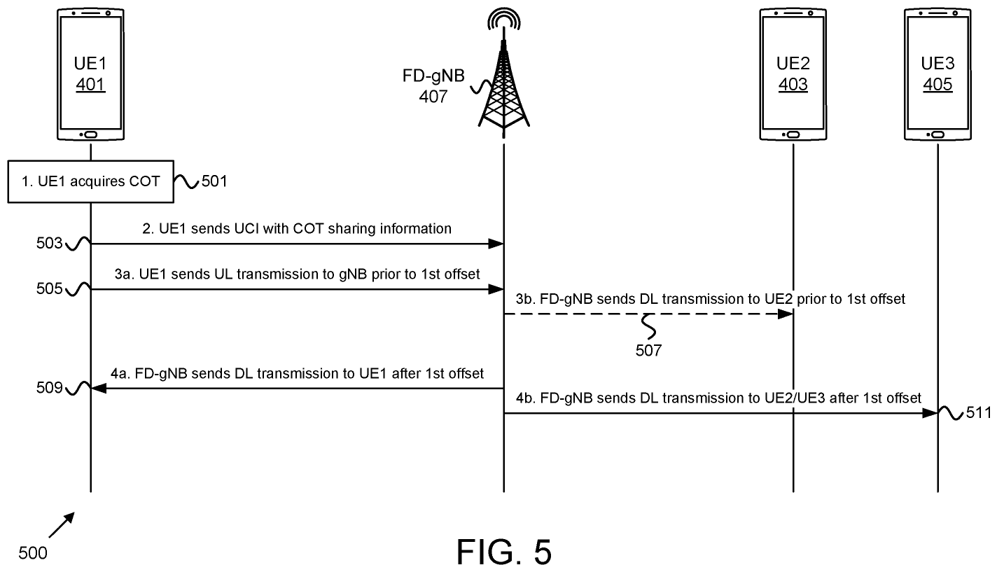

FIG. 5 depicts an exemplary procedure 500 of a full-duplex capable gNB sharing a UE-initiated COT. The procedure 500 involves the first UE 401 (i.e., one instance of the remote unit 105 and/or the UE 205), the FD-gNB 407 (i.e., one instance of the base unit 121 and/or the RAN node 207), the second UE 403 (i.e., another instance of the remote unit 105 and/or the UE 205), and the third UE 405 (i.e., another instance of the remote unit 105 and/or the UE 205).

At Step 1, the first UE 401 acquires a COT, e.g., as described above (see block 501).

At Step 2, the first UE 401 sends UCI to the FD-gNB 407, where the UCI contains COT sharing information as described herein (see messaging 503). As described above, the COT sharing information indicates at least a first offset.

Additionally, at Step 3a, the first UE 401 sends at least one UL transmission to the FD-gNB 407, i.e., prior to the first offset indicated in the COT sharing information (see messaging 505).

At conditional Step 3b, if the FD-gNB 407 has data/control messaging for the second UE 403 (i.e., a UE in the second set of UEs), then the FD-gNB 407 sends one or more DL transmissions towards the second UE 403 (and optionally additional UEs in the second set) (see messaging 507).

For Steps 4, it is assumed that the time indicated by the (first) offset is reached and thus the FD-gNB 407 is permitted to use a portion remaining in the COT to send DL transmissions to UEs in the RAN, including transmitting to the first UE 401 and/or other UEs in the first group of UEs.

At conditional step 4a, if the FD-gNB 407 has data/control messaging for the first UE 401, then the FD-gNB 407 sends at least one DL transmission to the first UE 401 (see messaging 509).

At conditional step 4b, if the FD-gNB 407 has data/control messaging for the second UE 403 and/or for the third UE 405, then the FD-gNB 407 sends at least one DL transmission to the pertinent UE(s) (see messaging 511). The procedure 500 ends.

In certain embodiments of the first solution, the first UE 401 sends a UCI indicating: A) a first COT sharing information including a first duration of DL transmission slots and a first offset from the end of the slot where the UCI is detected after which the FD-gNB 407 can share the COT; and B) a second COT sharing information including a second duration of DL transmission slots and a second offset from the end of the slot where the UCI is detected after which the FD-gNB 407 can share the COT.

In such embodiments, the FD-gNB 407 sends a DL transmission to a second UE 403 after the second offset if the second UE 403 belongs to a second set of UEs (e.g., as defined above). Further, the FD-gNB 407 sends a DL transmission to a third UE 405 after the first offset if the third UE 405 belongs to a first set of UEs, wherein the third UE 405 does not belong to the second set of UEs, and wherein the first UE 401 belongs to the first set of UEs.

In one implementation, the first duration of DL transmission slots and the second duration of the DL transmission slots occupy non-overlapping slots/time-instances (possible slots for FD DL and non-FD DL are different), e.g., the second offset starts from the end of the first duration of the DL transmission slots. In certain embodiments, the second offset is smaller than the first offset.

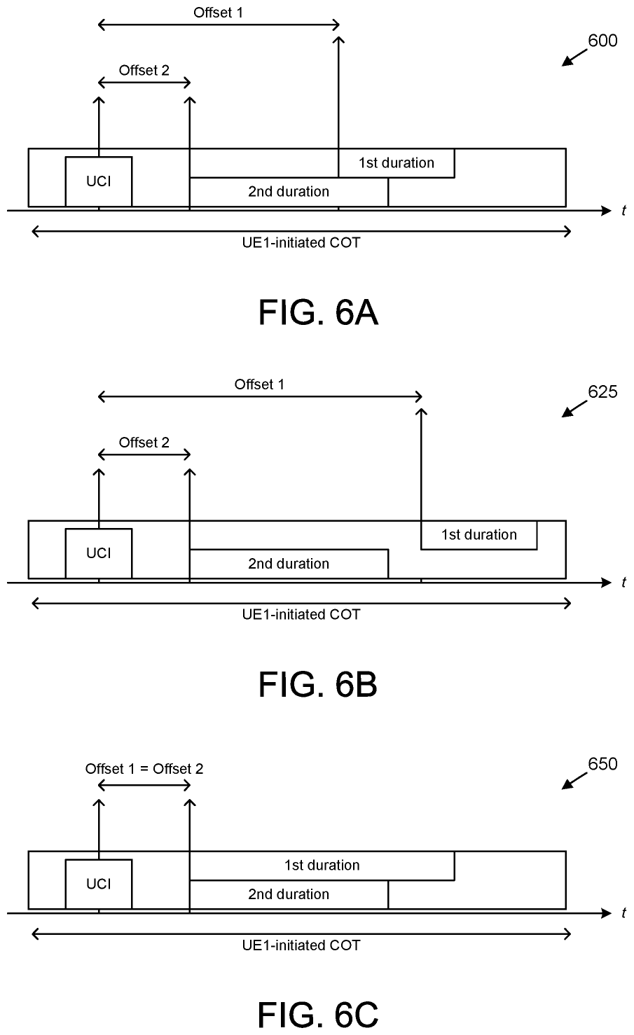

FIG. 6A depicts an exemplary UE-initiated COT 600, according to a first variant of the first solution. The UCI indicates a first and a second offset values with respect to UCI transmission. Here, the UCI also indicates a first duration and a second duration. Note that the first duration and first offset is applicable to DL transmissions which cannot be concurrent with the UL transmissions of the first UE 401. However, the second duration and second offset are applicable to DL transmissions which can be concurrent with the UL transmissions of the first UE 401.

FIG. 6B depicts an exemplary UE-initiated COT 625, according to a second variant of the first solution. In the second variant, the UCI indicates a first and a second offset values with respect to UCI transmission, as well as 1st and 2nd durations. In contrast to the first example, in the second example the 1st duration and 2nd durations are not overlapping in time.

FIG. 6C depicts an exemplary UE-initiated COT 650, according to a third variant of the first solution. In the third variant, the UCI indicates a first and a second offset values with respect to UCI transmission, as well as 1st and 2nd durations. In contrast to the first and second examples, in the third example the 1st duration and 2nd durations start from the same offset.

In one implementation, the second COT sharing information can be different among UCIs sent in different time instances within the UE-initiated COT or can result in having different durations/offsets for full-duplex downlink (“FD-DL”) transmissions. In another implementation, the latest received UCI is applicable.

In an embodiment of the first solution, the first UE 401 provides consistent COT sharing information in all the subsequent Configured Grant (“CG”) PUSCHs, if any, occurring within the same UE's initiated COT within a configured time window such that the same DL starting point and duration are maintained.

In implementations of the first solution, the duration and offset indication in the UCI include an indication to not allow DL transmissions to UEs of the first set within the first UE's initiated COT. This can be achieved for example by indicating a duration of 0, or an offset indicating infinity, or a non-numeric value respectively.

Regarding channel access procedure for a FD-gNB sharing a UE-initiated COT, according to embodiments of the first solution, the FD-gNB 407 performs LBT operation prior to DL transmission to another UE (e.g., the second UE 403). Here, the FD-gNB 407 determines whether the medium (e.g., channel) is occupied by more than just the first UE 401. In one embodiment, in response to determining the medium/channel is occupied at most by the first UE 401, the FD-gNB 407 can start DL transmission to another UE (e.g., to the second UE 403).

In an embodiment of channel access, the FD-gNB 407 determines whether the medium (e.g., channel) is occupied by more than just the first UE 401 by detecting the Demodulation Reference Signal (“DM-RS”) associated with the first UE's configured UL transmission and calculating the received power associated with the first UE's configured UL transmission. The FD-gNB 407 deducts or compensates for the first UE's received power/energy from the detected energy during the LBT operation. If the remaining energy is less than a threshold, then the FD-gNB 407 determines that the medium is occupied at most by the first UE 401 (i.e., and not by additional nodes).

In an embodiment of channel access, the LBT operation takes ‘y’ or at least ‘y’ symbols. In one implementation, ‘y’ is specified/dependent on SCS/determined based on the PUSCH decoding capability of the FD-gNB 407.

In an embodiment of channel access, when the LBT is performed over a duration in which the first UE 401 is configured with a configured UL transmission—such as UL CG/RACH/PUCCH messaging carrying Channel State Information (“CSI”) and/or Scheduling Request (“SR”), if the detected energy/power is less than a threshold, plus the received power from an UL transmission of the first UE 401, then the FD-gNB 407 can start DL transmission to another UE (e.g., to the second UE 403).

In one example, the threshold value is as defined in Rel-16/17, e.g., in 3GPP TS 37.213 (version 16.2.0), clause 4.1.5. In another example, the FD-gNB 407 performs LBT operation after a gap (e.g., of at least 16 μs) from the first UE's previous UL transmission burst or the FD-gNB's previous DL transmission burst. The duration of the gap may be a function of the transmission band, e.g., whether the band is within FR1 or FR2 as defined in 3GPP.

In a related embodiment, the FD-gNB 407 may measure the received power of the UL transmission of the first UE at least in a period (e.g., 9 μs, ‘x’ symbols, etc.) prior to performing LBT operation. The minimum period for the measurement may be a function of the transmission band, e.g., whether the band is within FR1 or FR2 as defined in 3GPP. In an example, the ‘x’ symbols should at least cover the DM-RS symbols corresponding to the configured UL transmission.

In an embodiment of channel access, the FD-gNB 407 sends a DL transmission to another UE (i.e., without performing LBT) while still receiving the first UL transmission burst from the first UE 401. The assumption here is that the other UE (e.g., second UE 403) cannot initiate its own COT during the first transmission burst from the first UE 401 as the other UE needs to perform LBT prior to transmitting especially assuming omni-directional sensing.

In a related embodiment, the FD-gNB 407 can send the DL transmission to the second UE 403 while still receiving the first UL transmission burst from the first UE 401 if the transmission parameters associated to the first transmission burst is restricted to a subset of possible transmission parameters, such as UL beams. In an example, the second UE 403 is indicated if the FD-gNB 407 is using its own COT or another UE's COT.

In an embodiment of channel access, the FD-gNB 407 (e.g., after the first UL transmission burst in one of the other embodiments) indicates to the first UE 401 a set of time instances (such as slots/symbols/FFPs) in which the FD-gNB 407 may operate in FD mode. One motivation or consequence of communicating such information is that the first UE 401 could impose restrictions on the first UE's transmission parameters, such as transmit power, transmission beams, MCS, etc. to make UL-DL separation possible at the FD-gNB 407 or not to harm DL reception of other UEs receiving DL transmission from the FD-gNB 407. In an example, the FD-gNB 407 indicates the set of time instances in which corresponding restrictions are applicable at the first UE 401.

In a related embodiment, the first UE 401 upon reception of the indication indicating the set of time instances, would use a subset of possible transmission parameters for transmitting UL. In an example, the FD-gNB 407 indicates particular transmission beam to use for configured grant UL transmissions of the first UE 401.

In a related embodiment, the indication of the set of time instances triggers use of directional sensing/LBT and/or use of receiver-assisted/receiver-aided LBT mechanisms (such as a transmitter-receiver handshake (e.g., RTS/CTS, or similar) information exchange between transmitter and receiver). In an example, the FD-gNB 407 performs directional LBT for a first beam and, if it senses the medium as free, it would send a first handshake signal (such as Ready-To-Send (“RTS”)). A second UE 403, which is associated with the first beam, would then provide a second handshake signal (such as Clear-To-Send (“CTS”)) in response to receiving the first handshake signal. Upon reception of the second handshake signal, the FD-gNB 407 determines the medium is free and transmit a DL signal to the second UE 403.

In an example, at least during a fixed frame period (“FFP”) initiated by the first UE 401, the second UE 403 transmits the second handshake signal in a licensed channel or in another unlicensed medium for which the second UE 403 is allowed to transmit. In an example, the second UE 403 determines if a COT/FFP is a gNB-initiated COT or another UE's COT, e.g., based on a gNB indication such as gNB indication at the beginning of the COT/FFP such as via broadcast signaling or via group-common DCI signaling.

In an embodiment of channel access, full duplex (“FD”) transmissions are possible only during gNB-initiated COT, and not during UE-initiated COTs. Alternatively, whether FD operation (e.g., LBT operation corresponding to/facilitating FD operation) is allowed during a UE-initiated COT is configurable/indicatable via DCI/MAC-CE signaling. In an example, at least during an FFP initiated by the first UE 401, the FD-gNB 407 indicates a direction (or Transmission Configuration Indicator (“TCI”) state(s) or Reference Signal (“RS”) (e.g., QCL-TypeD Synchronization Signal Block (“SSB”)/CSI-RS) indices or spatial relations) in which a second UE 403 should not transmit with such that the resulting UL signal from the second UE 403 would not cause interruption to an UL transmission by the first UE. In another example, the FD-gNB 407 indicates the beam direction associated with the first UE 401 (i.e., which initiated the COT) in a GC-DCI or in a UE-specific DCI to the second UE 403.

In some embodiments of channel access, the UE-initiated COT is semi-statically configured to be available for FD-gNB 407, i.e., FD-gNB operation could be applied for entire duration of the UE-initiated COT (except the idle period). Here, a first UE 401 initiates a COT and starts UL transmission to one FD-gNB 407, then the one FD-gNB 407 can start DL transmission to one or multiple UEs in a second set as soon as it starts receiving UL from the first UE 401 (i.e., within the UE-initiated COT of first UE), where the first UE 401 is different from the UEs in the second set (i.e., does not belong to the second set).

The FD-gNB 407 may indicate to the first UE 401 the set of symbols where the FD-gNB 407 intends to perform DL transmission. The first UE 401 can perform second burst of UL transmission (within the UE-initiated COT of first UE): A) after any gap (no threshold as long as the COT duration is still available) from the end of first burst of its UL transmission and without performing any sensing, and B) except when it is receiving DL from the one FD-gNB (within the UE-initiated COT of first UE), but DL transmission to the second set of UEs could still be on-going, and C) when the first UE 401 knows the channel is occupied by FD-gNB for DL (to second set of UEs) based on the set of symbols indicated by the FD-gNB 407 for performing DL.

For the second solution, it is assumed that the FD-gNB 407 initiates a COT, wherein one or more UEs may share the gNB-initiated COT. According to embodiments of the second solution, the FD-gNB 407 indicates whether its acquired COT is a ‘FD-gNB-COT’ or a ‘non-FD gNB-COT.’ In a related embodiment, only a subset of UEs is allowed to share the FD-gNB-COT, i.e., only UEs can share the COT which create negligible interference to the UEs to which the FD-gNB 407 would send DL transmissions.

In one example, the FD-gNB 407 uses Slot Format Indicator (“SFI”) signaling to indicate all DL pattern (over the gNB-COT) to the UEs not allowed to share the FD-gNB-COT. In another example, the idle-mode UEs are not allowed to send Random-Access Channel (“RACH”) over the FD-gNB-COT. In a third example, the FD-gNB 407 uses broadcast signaling to indicate FD-gNB-COT bitmaps (e.g., which gNB-COTs in FBE mode are FD-gNB-COT).

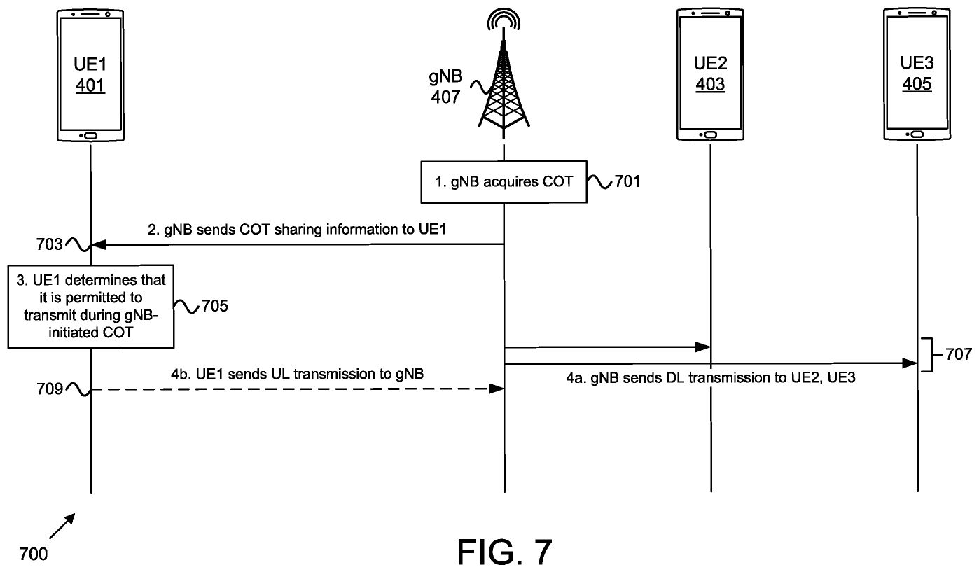

FIG. 7 depicts an exemplary procedure 700 of a UE sharing a COT initiated by a full-duplex capable gNB. The procedure 700 involves the first UE 401 (i.e., one instance of the remote unit 105 and/or the UE 205), the FD-gNB 407 (i.e., one instance of the base unit 121 and/or the RAN node 207), the second UE 403 (i.e., another instance of the remote unit 105 and/or the UE 205), and the third UE 405 (i.e., another instance of the remote unit 105 and/or the UE 205).

At Step 1, the FD-gNB 407 acquires a COT, e.g., as described above (see block 701).

At Step 2, the FD-gNB 407 sends COT sharing information to the first UE 401 (see messaging 703). As described above, the COT sharing information indicates whether a UE is allowed to share the gNB-initiated COT. In one embodiment, the COT sharing information indicates whether the gNB-initiated COT is a FD-gNB-COT or a non-FD-gNB-COT. In certain embodiments, the COT sharing information may indicate which UEs are permitted to share a FD-gNB-COT.

At Step 3, the first UE 401 determines whether is it permitted to share the gNB-initiated COT. In the depicted embodiment, it is assumed that the first UE 401 determines that it is permitted to transmit during the gNB-initiated COT (see block 705).

At step 4a, the FD-gNB 407 transmits at least one DL transmission to a UE in the RAN, such as the second UE 403 and/or the third UE 405 (see messaging 707).

At conditional Step 4b, if the first UE 401 has uplink data/control messaging to send, then the first UE 401 sends at least one UL transmission to the FD-gNB 407 (see messaging 709). The procedure 700 ends.

In an embodiment of the second solution, the FD-gNB 407 indicates a group-ID of UEs (e.g., via group-common DCI signaling) that can share the gNB-COT. In an example, one codepoint of the GC-DCI signaling corresponds to ‘no restriction’ (allows all UEs to share the gNB-COT). In a second example, the GC-DCI signaling is applicable to a certain duration of the gNB-COT (e.g., GC-DCI indicates if the DCI is applicable to a first duration, a second duration, etc.), potentially the DCI may also indicate an offset from which the certain duration is applicable; wherein the offset is defined with respect to the time instance the DCI is sent (e.g., last Physical Downlink Control Channel (“PDCCH”) symbol or the last symbol of the CORESET). In a third example, the GC-DCI signaling is sent at the beginning of a gNB-COT. In a fourth example, the GC-DCI signaling can be sent also in certain locations of the gNB-COT (e.g., the FD-gNB 407 senses the medium and, if free, sends GC-DCI in certain locations).

In an embodiment of the second solution, the FD-gNB 407 indicates a set of feasible beams (or TCI states or RS (e.g., QCL-TypeD SSB/CSI-RS) indices or spatial relations) in which the UEs can use to share the FD-gNB-COT (or to initiate a UE-COT). In an example, the indication maybe sent using a broadcast channel/signal, such as System Information Block (“SIB”) signaling and/or via DCI (e.g., GC-DCI) signaling.

In an embodiment of the second solution, the FD-gNB 407 indicates a set of time instances for FD operation, wherein such indication triggers use of directional sensing/LBT and/or use of receiver-assisted/receiver-aided LBT mechanisms (such as a transmitter-receiver handshake (RTS/CTS like) information exchange between transmitter and receiver). In an example, the FD-gNB 407 may perform directional LBT for a first beam and, if it senses the medium as free, it would send a first handshake signal (such as RTS). A UE which is associated with the first beam, provides a second handshake signal (such as CTS) in response to receiving the first handshake signal. Upon reception of the second handshake signal, the FD-gNB 407 determines the medium is free and transmit a DL signal to the UE.

In an embodiment of the second solution, a second UE 403 can be informed by FD-gNB 407 that the second UE 403 does not need to perform any LBT for its UL transmission. In an example, the FD-gNB 407 operating in FD mode initiates a COT/FFP, and then uses an advertised duration to transmit DL to a first group of UEs. During that advertised duration, UEs from a second group could be allowed to transmit UL without performing LBT prior to their UL transmissions, since the channel is occupied by the FD-gNB 407 in DL. The advertised duration (maybe together with a UE group ID) could be indicated in a group-common DCI format such as DCI 2_0.

In a related embodiment, a UE is configured with one or more of a servingCellId/LBT bandwidth (“BW”) identifier (“ID”)/position in DCI (such as DCI parameters defined for DCI format 2_0/2_1), etc., with which the UE can understand if a DCI indication containing the advertised duration/LBT skipping is applicable to the UE.

In a related implementation, the second group is composed of a single UE. In another implementation, the second group is comprised of multiple UEs, wherein the FFPs associated with different UEs are non-overlapping. Such condition might be useful in not allowing multiple concurrent UL transmissions (e.g., having same beam) from more than one UE to the FD-gNB 407.

In another implementation, the second group of UEs is comprised of UEs having transmission beams resulting in orthogonal receive signals/beams at the FD-gNB 407. In an implementation, the second group of UEs is comprised of UEs having UL transmission beams/characteristics for which the FD-gNB 407 can suppress the DL interference on the received UL transmission, and/or for which the UL transmission does not impact (significantly) the DL transmissions to the first group of UEs.

In another embodiment of the second solution, in a gNB-initiated COT, the UE can recommend to the FD-gNB 407 not to have a coinciding DL transmission with its UL transmission (e.g., using similar mechanisms of UCI transmission as mentioned above).

According to Rel-16 TS 38.213, a UE can be configured with the Information Element (“IE”) SlotFormatIndicator that is used to configure monitoring a Group-Common-PDCCH for Slot-Format-Indicators (“SFI”). For shared spectrum channel access, the SlotFormatIndicator can include the parameter AvailableRB-SetsPerCell and the parameter CO-DurationsPerCell that configure the followings, respectively:
1) A location of an available Resource Block (“RB”) set indicator field in DCI format 2_0 that is: A) one bit, if intraCellGuardBandsDL-List for the serving cell indicates no intra-cell guard-bands are configured, where a value of ‘1’ indicates that the serving cell is available for receptions, a value of ‘0’ indicates that the serving cell is not available for receptions, by availableRB-SetsPerCell, and the serving cell remains available or unavailable for reception until the end of the remaining channel occupancy duration, or B) a bitmap having a one-to-one mapping with the RB sets (see 3GPP TS 38.214) of the serving cell, if intraCellGuardBandsDL-List for the serving cell indicates intra-cell guard-bands are configured, where the bitmap includes N_{RB,set,DL} bits and N_{RB,set,DL} is the number of RB sets in the serving cell, a value of ‘1’ indicates that an RB set is available for receptions, a value of ‘0’ indicates that an RB set is not available for receptions, by availableRB-SetsPerCell and a RB set remains available or unavailable for receptions until the end of the remaining channel occupancy duration.
2) A location of a channel occupancy duration field in DCI format 2_0, by CO-DurationsPerCell, that indicates a remaining channel occupancy duration for the serving cell starting from a first symbol of a slot where the UE detects the DCI format 2_0 by providing a value from co-DurationList. The channel occupancy duration field includes max{[log₂ (COdurationListSize)], 1} bits, where COdurationListSize is the number of values provided by co-DurationList. If CO-DurationsPerCell is not provided, the remaining channel occupancy duration for the serving cell is a number of slots, starting from the slot where the UE detects the DCI format 2_0, that the SFI-index field value provides corresponding slot formats. In one embodiment, a reference SCS configuration for co-DurationList, is indicated by subcarrierSpacing-r16.

Further, if a UE is provided channelAccessMode=‘dynamic’ and is provided availableRB-SetsToAddModList and availableRB-SetsToRelease, the UE expects to be provided co-DurationsP erCellToAddModList and co-DurationsPerCellToReleaseList and/or slotFormatCombToAddModList and slotFormatCombToReleaseList.

If neither CO-DurationPerCell-r16 nor SlotFormatCombinationsPerCell are provided and if ChannelAccessMode-r16=‘semistatic’ is provided, a UE assumes that channel occupancy time defined in clause 4.3 of TS 37.213 is the remaining channel occupancy duration if a DL transmission burst(s) is detected within the channel occupancy time.

In one embodiment, for operation with shared spectrum channel access, if a UE is configured by higher layers to receive a CSI-RS in a full duplex aware mode and the UE is provided CO-DurationsPerCell, for a set of symbols of a slot that are indicated as uplink or flexible by tdd-UL-DL-ConfigurationCommon or tdd-UL-DL-ConfigurationDedicated, or when tdd-UL-DL-ConfigurationCommon and tdd-UL-DL-ConfigurationDedicated are not provided, the UE performs the CSI-RS reception in the set of symbols of the slot that are within the remaining channel occupancy duration.

In one embodiment, for operation with shared spectrum channel access, if a UE receives a CG PUSCH configuration, a CSI report configuration including a semi-static PUCCH resource for CSI reporting, a periodic Sounding Reference Signal (“SRS”) resource configuration, or a Physical Random Access Channel (“PRACH”) configuration with a full duplex aware mode and the UE is provided CO-DurationsPerCell, for a set of symbols of a slot that are indicated as downlink or flexible by tdd-UL-DL-ConfigurationCommon or tdd-UL-DL-ConfigurationDedicated, or when tdd-UL-DL-ConfigurationCommon and tdd-UL-DL-ConfigurationDedicated are not provided, the UE performs transmission of a corresponding (CG) PUSCH, PUCCH, SRS, or PRACH in the set of symbols of the slot that are within the remaining channel occupancy duration.

In one embodiment, for operation with shared spectrum channel access, if a UE is provided csi-RS-ValidationWith-DCI, is not provided CO-DurationsPerCell, and is not provided SlotFormatCombinationsPerCell, and if the UE is configured by higher layers to receive a CSI-RS in a set of symbols of a slot, the UE does not expect to detect a first DCI format indicating an aperiodic CSI-RS reception or scheduling a PDSCH reception in the set of symbols of the slot and detects a second DCI format, Random-Access Response (“RAR”) UL grant, fallbackRAR UL grant, or successRAR indicating a PUSCH, PUCCH, PRACH, or SRS transmission in at least one symbol of the set of symbols of the slot, unless the UE indicates a full duplex capability to a network entity for a given cell or for a given combination of carrier aggregation cells.

In an example, for channel access procedures based on semi-static channel occupancy, a channel occupancy initiated by a FD-gNB 407 and shared with UE(s) shall satisfy the following:

The FD-gNB 407 shall transmit a DL transmission burst starting at the beginning of the channel occupancy time immediately after sensing the channel to be idle for at least a sensing slot duration T_si=9 μs. If the channel is sensed to be busy, then the FD-gNB 407 shall not perform any transmission during the current period. The FD-gNB 407 may transmit a DL transmission burst(s) within the channel occupancy time immediately after sensing the channel to be idle for at least a sensing slot duration T_si=9 μs, if the gap between the DL transmission burst(s) and any previous transmission burst is more than 16 μs.

If the FD-gNB 407 is capable of full duplex operation, then the FD-gNB 407 may transmit a DL transmission burst(s) while receiving an UL transmission burst(s) within the channel occupancy time. If the gNB transmits an indication of full duplex operation for a given channel occupancy, a UE may transmit UL transmission burst(s) without sensing the channel after detection of a DL transmission burst(s) including the indication of gNB's full duplex operation within the channel occupancy time. The FD-gNB 407 and UEs shall not transmit any transmissions in a set of consecutive symbols for a duration of at least T_z=max(0.05T_x, 100 μs), where T_x is period (in ms) for periodic channel occupancy initiated by the FD-gNB 407, before the start of the next period.

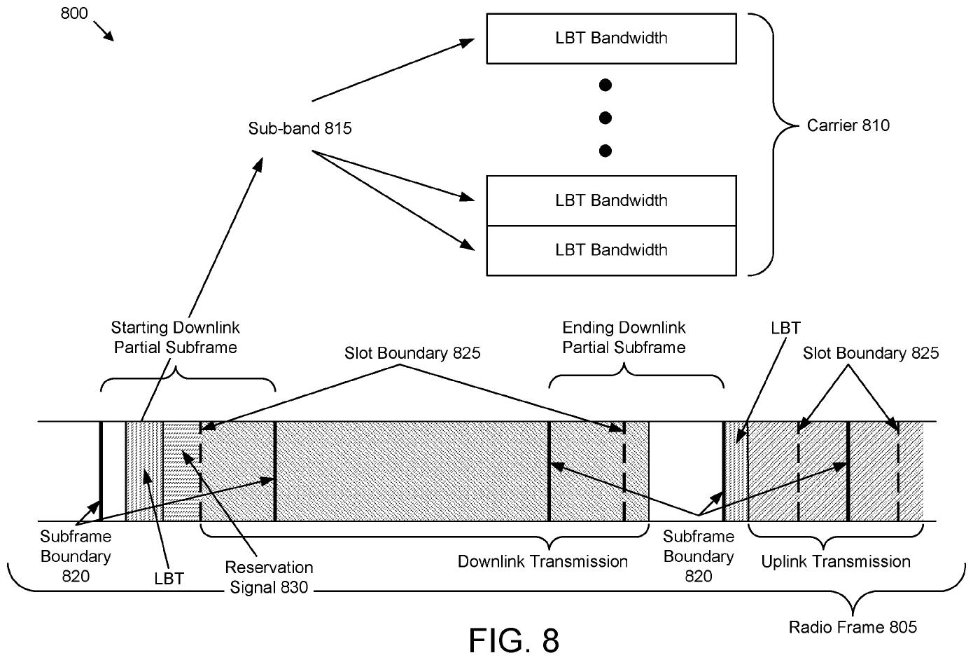

FIG. 8 depicts an LBT procedure 800 for a radio frame 805 for unlicensed communication, according to embodiments of the disclosure. When a communication channel is a wide bandwidth unlicensed carrier 810 (e.g., several hundred MHz, the Clear Channel Assessment (“CCA”), e.g., LBT procedure, relies on detecting the energy level on multiple sub-bands 815 of the communications channel as shown in FIG. 8. The LBT parameters (such as type/duration, clear channel assessment parameters, etc.) are configured in the UE by a RAN node, such as the gNB. In one embodiment, the LBT procedure is performed at the physical layer. When performing omni-directional LBT, the entity (i.e., gNB or UE) may use an omnidirectional sensing beam. Alternatively, the entity may simultaneously perform directional LBT using multiple beams (i.e., corresponding to multiple device panels) in order to simulate omnidirectional sensing. When performing directional LBT, the entity (i.e., gNB or UE) performs LBT for a given beam (i.e., corresponding to a given spatial direction). Note that each directional beam may correspond to one or more device panels.

FIG. 8 also depicts frame structure of the radio frame 805 for unlicensed communication between the UE and gNB. The radio frame 805 may be divided into subframes (indicated by subframe boundaries 820) and may be further divided into slots (indicated by slot boundaries 825). The radio frame 805 uses a flexible arrangements where uplink and downlink operations are on the same frequency channel but are separated in time. However, the subframes are not configured as a downlink subframe or an uplink subframe and a particular subframe may be used by either the UE or gNB. As discussed previously, LBT is performed prior to a transmission. Where LBT does not coincide with a slot boundary 825, a reservation signal 830 may be transmitted to reserve (i.e., occupy) the channel until the slot boundary is reached and data transmission begins.

In some embodiments, the terms antenna, panel, and antenna panel are used interchangeably. An antenna panel may be a hardware that is used for transmitting and/or receiving radio signals at frequencies lower than 6 GHz, e.g., FR1, or higher than 6 GHz, e.g., Frequency Range #2 (“FR2”, referring to radio frequencies from 24.25 GHz to 52.6 GHz) or millimeter wave (“mmWave”). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device (e.g., the UE 205, or another node) to amplify signals that are transmitted or received from one or multiple spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. A capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices such as a central unit (“CU”), it can be used for signaling or local decision making.

In some embodiments, an antenna panel may be a physical or logical antenna array comprising a set of antenna elements or antenna ports that share a common or a significant portion of an RF chain (e.g., in-phase/quadrature (“I/Q”) modulator, analog-to-digital (“A/D”) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on implementation, a “panel” can have at least one of the following functionalities as an operational role of Unit of antenna group to control its transmit (“Tx”) beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or comprise a duration of time over which the network entity (e.g., the RAN node 207) assumes there will be no change to the mapping. Device may report its capability with respect to the “panel” to the network entity. The device capability may include at least the number of “panels. In one implementation, the device may support transmission from one beam within a panel; with multiple panels, more than one beam (one beam per panel) may be used for transmission. In another implementation, more than one beam per panel may be supported/used for transmission.

In some of the embodiments described, an antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial receive (“Rx”) parameters. Two antenna ports may be quasi-located with respect to a subset of the large-scale properties and different subset of large-scale properties may be indicated by a Quasi-Co-Location (“QCL”) Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
QCL-TypeA′: {Doppler shift, Doppler spread, average delay, delay spread}
QCL-TypeB′: {Doppler shift, Doppler spread}
QCL-TypeC′: {Doppler shift, average delay}
QCL-TypeD′: {Spatial Rx parameter}

Spatial Rx parameters may include one or more o£ angle of arrival (“AoA”), Dominant AoA, average AoA, angular spread, Power Angular Spectrum (“PAS”) of AoA, angle of departure (“AoD”), average AoD, PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, i.e., the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the embodiments described, a TCI-state (Transmission Configuration Indication) associated with a target transmission can indicate parameters for configuring a quasi-collocation relationship between the target transmission (e.g., target RS of DM-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between an Integrated Access and Backhaul Distributed Unit (“IAB-DU”) of a parent Integrated Access and Backhaul node (“TAB node”—e.g., a type of a 5G relay station) and an Integrated Access and Backhaul Mobile Termination (“IAB-MT”) of a child TAB node). In some of the embodiments described, a TCI state comprises at least one source RS to provide a reference (device assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

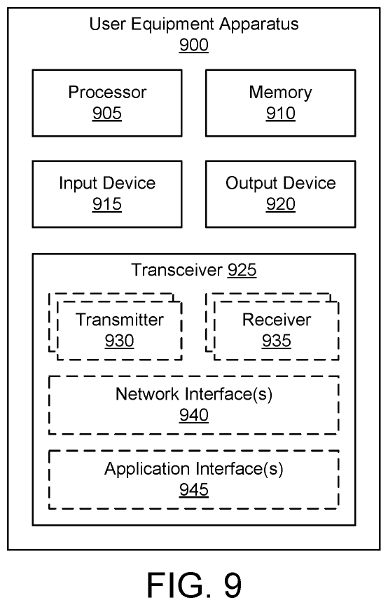

FIG. 9 depicts a user equipment apparatus 900 that may be used for full duplex operation in unlicensed spectrum, according to embodiments of the disclosure. In various embodiments, the user equipment apparatus 900 is used to implement one or more of the solutions described above. The user equipment apparatus 900 may be one embodiment of the remote unit 105 and/or the UE 205, as described above. Furthermore, the user equipment apparatus 900 may include a processor 905, a memory 910, an input device 915, an output device 920, and a transceiver 925.

In some embodiments, the input device 915 and the output device 920 are combined into a single device, such as a touchscreen. In certain embodiments, the user equipment apparatus 900 may not include any input device 915 and/or output device 920. In various embodiments, the user equipment apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. In some embodiments, the transceiver 925 communicates with one or more cells (or wireless coverage areas) supported by one or more base units 121. In various embodiments, the transceiver 925 is operable on unlicensed spectrum. Moreover, the transceiver 925 may include multiple UE panels supporting one or more beams. Additionally, the transceiver 925 may support at least one network interface 940 and/or application interface 945. The application interface(s) 945 may support one or more APIs. The network interface(s) 940 may support 3GPP reference points, such as Uu, N1, PC5, etc. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the processor 905 controls the user equipment apparatus 900 to implement the above described UE behaviors. In certain embodiments, the processor 905 may include an application processor (also known as “main processor”) which manages application-domain and operating system (“OS”) functions and a baseband processor (also known as “baseband radio processor”) which manages radio functions.

In various embodiments, via the transceiver 925, the processor 905 receives COT sharing information from a RAN node. Here, the COT sharing information indicates that the RAN node is operating in full-duplex mode during a RAN-initiated COT. The processor 905 determines whether the apparatus 900 is permitted to transmit during the RAN-initiated COT. In response to determining that the apparatus 900 is permitted to transmit during the RAN-initiated COT, the processor 905 controls the transceiver to transmit a first set of uplink transmissions within the RAN-initiated COT.

In some embodiments, the COT sharing information includes a slot format indicator. In such embodiments, determining that the apparatus 900 is permitted to transmit during the RAN-initiated COT comprises identifying that uplink transmission is allowed in the RAN-initiated COT based on the slot format indicator. In some embodiments, determining that the apparatus 900 is permitted to transmit during the RAN-initiated COT includes receiving a bitmap in broadcast signaling, said bitmap indicating that the COT is a full duplex, RAN-initiated COT.

In some embodiments, the COT sharing information includes a set of feasible beams for sharing a full duplex, RAN-initiated COT. In such embodiments, transmitting the first set of uplink transmissions includes transmitting on at least one beam from the set of feasible beams. In some embodiments, the COT sharing information further indicates a first duration during which the RAN node transmits downlink transmissions. In such embodiments, transmitting the first set of uplink transmissions includes transmitting without performing a listen-before talk procedure when the first set of uplink transmissions is transmitted within the first duration.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to full duplex operation in unlicensed spectrum. For example, the memory 910 may store various parameters, panel/beam configurations, resource assignments, policies, and the like as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 920 may include a wearable display separate from, but communicatively coupled to, the rest of the user equipment apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all or portions of the output device 920 may be integrated with the input device 915. For example, the input device 915 and output device 920 may form a touchscreen or similar touch-sensitive display. In other embodiments, the output device 920 may be located near the input device 915.

The transceiver 925 communicates with one or more network functions of a mobile communication network via one or more access networks. The transceiver 925 operates under the control of the processor 905 to transmit messages, data, and other signals and also to receive messages, data, and other signals. For example, the processor 905 may selectively activate the transceiver 925 (or portions thereof) at particular times in order to send and receive messages.

The transceiver 925 includes at least transmitter 930 and at least one receiver 935. One or more transmitters 930 may be used to provide UL communication signals to a base unit 121, such as the UL transmissions described herein. Similarly, one or more receivers 935 may be used to receive DL communication signals from the base unit 121, as described herein. Although only one transmitter 930 and one receiver 935 are illustrated, the user equipment apparatus 900 may have any suitable number of transmitters 930 and receivers 935. Further, the transmitter(s) 930 and the receiver(s) 935 may be any suitable type of transmitters and receivers. In one embodiment, the transceiver 925 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 925, transmitters 930, and receivers 935 may be implemented as physically separate components that access a shared hardware resource and/or software resource, such as for example, the network interface 940.

In various embodiments, one or more transmitters 930 and/or one or more receivers 935 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 930 and/or one or more receivers 935 may be implemented and/or integrated into a multi-chip module. In some embodiments, other components such as the network interface 940 or other hardware components/circuits may be integrated with any number of transmitters 930 and/or receivers 935 into a single chip. In such embodiment, the transmitters 930 and receivers 935 may be logically configured as a transceiver 925 that uses one more common control signals or as modular transmitters 930 and receivers 935 implemented in the same hardware chip or in a multi-chip module.

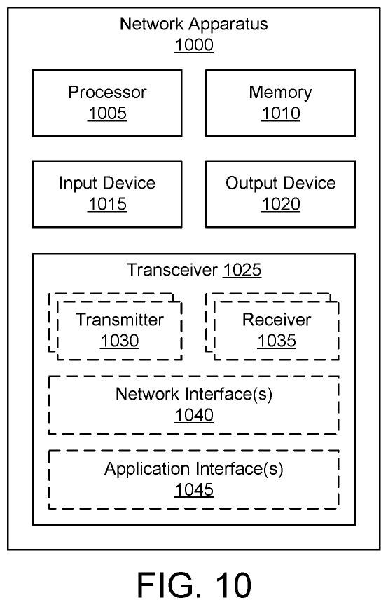

FIG. 10 depicts a network apparatus 1000 that may be used for full duplex operation in unlicensed spectrum, according to embodiments of the disclosure. In one embodiment, network apparatus 1000 may be one implementation of a RAN device, such as the base unit 121 and/or RAN node 207, as described above. Furthermore, the network apparatus 1000 may include a processor 1005, a memory 1010, an input device 1015, an output device 1020, and a transceiver 1025.

In some embodiments, the input device 1015 and the output device 1020 are combined into a single device, such as a touchscreen. In certain embodiments, the network apparatus 1000 may not include any input device 1015 and/or output device 1020. In various embodiments, the network apparatus 1000 may include one or more of: the processor 1005, the memory 1010, and the transceiver 1025, and may not include the input device 1015 and/or the output device 1020.

As depicted, the transceiver 1025 includes at least one transmitter 1030 and at least one receiver 1035. Here, the transceiver 1025 communicates with one or more remote units 105. Additionally, the transceiver 1025 may support at least one network interface 1040 and/or application interface 1045. The application interface(s) 1045 may support one or more APIs. The network interface(s) 1040 may support 3GPP reference points, such as Uu, N1, N2 and N3. Other network interfaces 1040 may be supported, as understood by one of ordinary skill in the art.

The processor 1005, in one embodiment, may include any known controller capable of executing computer-readable instructions and/or capable of performing logical operations. For example, the processor 1005 may be a microcontroller, a microprocessor, a CPU, a GPU, an auxiliary processing unit, a FPGA, or similar programmable controller. In some embodiments, the processor 1005 executes instructions stored in the memory 1010 to perform the methods and routines described herein. The processor 1005 is communicatively coupled to the memory 1010, the input device 1015, the output device 1020, and the transceiver 1025.

In various embodiments, the network apparatus 1000 is a RAN node (e.g., gNB) that communicates with one or more UEs, as described herein. In such embodiments, the processor 1005 controls the network apparatus 1000 to perform the above described RAN behaviors. When operating as a RAN node, the processor 1005 may include an application processor (also known as “main processor”) which manages application-domain and operating system (“OS”) functions and a baseband processor (also known as “baseband radio processor”) which manages radio functions.

In various embodiments, via the transceiver 1025, the processor 1005 receives an UCI from a first UE, the UCI containing first COT sharing information and second COT sharing information. Here, the first COT sharing information comprises a first duration and a first offset from the end of a slot where the UCI is detected and the second COT sharing information comprises a second duration, where the first duration and the second durations are different. The processor 1005 that controls the transceiver 1025 to transmit a first set of DL transmissions to a first set of UEs for the duration of the first duration and transmit a second set of DL transmissions to a second set of UEs for the duration of the second duration, where the first set of DL transmissions occurs after the first offset and where the first UE belongs to the first set of UEs.

In various embodiments, the RAN node is capable of full-duplex operation. In some embodiments, the processor 1005 further controls the transceiver 1025 to transmit the second DL transmissions while concurrently receiving UL transmissions from the first UE. In some embodiments, the processor 1005 determines that the RAN node is permitted to transmit the second DL transmission after the last symbol of the UCI.

In some embodiments, the second COT sharing information further includes a second offset from the end of the slot where the UCI is detected, where the RAN node is permitted to transmit the second DL transmission after the second offset. In certain embodiments, the second offset is equal to the first offset, where the first set of DL transmissions and the second set of DL transmissions do not overlap in time. In certain embodiments, the first offset and the second offset are defined from the last symbol of the UCI.

In some embodiments, the first UE is capable of adapting communication to facilitate full duplex operation by the RAN node. In such embodiments, the processor may further configure the first UE to send the first COT sharing information and the second COT sharing information in the UCI.

In some embodiments, the processor 1005 further determines whether the medium (i.e., channel) is occupied at most by the first UE and controls the transceiver 1025 to transmit to a second UE in response to determining the medium is occupied at most by the first UE. In such embodiments, the RAN node simultaneously receives an UL transmission from the first UE while transmitting a DL transmission to the second UE. In certain embodiments, determining if the medium is occupied at most by the first UE includes determining a first received power (alternatively, first received energy) associated with the first UE's UL transmission and determining whether the detected energy during an LBT period is not more than an offset with respect to the first received power (alternatively, first received energy).

The memory 1010, in one embodiment, is a computer readable storage medium. In some embodiments, the memory 1010 includes volatile computer storage media. For example, the memory 1010 may include a RAM, including dynamic RAM (“DRAM”), synchronous dynamic RAM (“SDRAM”), and/or static RAM (“SRAM”). In some embodiments, the memory 1010 includes non-volatile computer storage media. For example, the memory 1010 may include a hard disk drive, a flash memory, or any other suitable non-volatile computer storage device. In some embodiments, the memory 1010 includes both volatile and non-volatile computer storage media.

In some embodiments, the memory 1010 stores data related to full duplex operation in unlicensed spectrum. For example, the memory 1010 may store parameters, configurations, resource assignments, policies, and the like, as described above. In certain embodiments, the memory 1010 also stores program code and related data, such as an operating system or other controller algorithms operating on the apparatus 1000.

The input device 1015, in one embodiment, may include any known computer input device including a touch panel, a button, a keyboard, a stylus, a microphone, or the like. In some embodiments, the input device 1015 may be integrated with the output device 1020, for example, as a touchscreen or similar touch-sensitive display. In some embodiments, the input device 1015 includes a touchscreen such that text may be input using a virtual keyboard displayed on the touchscreen and/or by handwriting on the touchscreen. In some embodiments, the input device 1015 includes two or more different devices, such as a keyboard and a touch panel.

The output device 1020, in one embodiment, is designed to output visual, audible, and/or haptic signals. In some embodiments, the output device 1020 includes an electronically controllable display or display device capable of outputting visual data to a user. For example, the output device 1020 may include, but is not limited to, an LCD display, an LED display, an OLED display, a projector, or similar display device capable of outputting images, text, or the like to a user. As another, non-limiting, example, the output device 1020 may include a wearable display separate from, but communicatively coupled to, the rest of the network apparatus 1000, such as a smart watch, smart glasses, a heads-up display, or the like. Further, the output device 1020 may be a component of a smart phone, a personal digital assistant, a television, a table computer, a notebook (laptop) computer, a personal computer, a vehicle dashboard, or the like.

In certain embodiments, the output device 1020 includes one or more speakers for producing sound. For example, the output device 1020 may produce an audible alert or notification (e.g., a beep or chime). In some embodiments, the output device 1020 includes one or more haptic devices for producing vibrations, motion, or other haptic feedback. In some embodiments, all or portions of the output device 1020 may be integrated with the input device 1015. For example, the input device 1015 and output device 1020 may form a touchscreen or similar touch-sensitive display. In other embodiments, the output device 1020 may be located near the input device 1015.

The transceiver 1025 includes at least transmitter 1030 and at least one receiver 1035. One or more transmitters 1030 may be used to communicate with the UE, as described herein. Similarly, one or more receivers 1035 may be used to communicate with network functions in the Public Land Mobile Network (“PLMN”) and/or RAN, as described herein. Although only one transmitter 1030 and one receiver 1035 are illustrated, the network apparatus 1000 may have any suitable number of transmitters 1030 and receivers 1035. Further, the transmitter(s) 1030 and the receiver(s) 1035 may be any suitable type of transmitters and receivers.

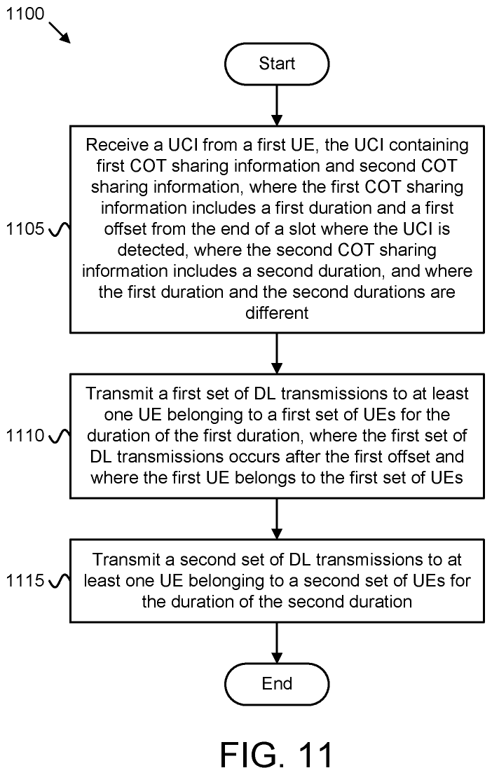

FIG. 11 depicts one embodiment of a method 1100 for full duplex operation in unlicensed spectrum, according to embodiments of the disclosure. In various embodiments, the method 1100 is performed by a network entity, such as the base unit 121, the RAN node 207, and/or the network apparatus 1000, described above as described above. In some embodiments, the method 1100 is performed by a processor, such as a microcontroller, a microprocessor, a CPU, a GPU, an auxiliary processing unit, a FPGA, or the like.

The method 1100 begins and receives 1105 a UCI from a first UE, the UCI containing first COT sharing information and second COT sharing information. Here, the first COT sharing information includes a first duration and a first offset from the end of a slot where the UCI is detected. The second COT sharing information includes a second duration, where the first duration and the second durations are different. The method 1100 includes transmitting 1110 a first set of DL transmissions to a first set of UEs for the duration of the first duration, where the first set of DL transmissions occurs after the first offset and where the first UE belongs to the first set of UEs. The method 1100 includes transmitting 1115 a second set of DL transmissions to a second set of UEs for the duration of the second duration. The method 1100 ends.

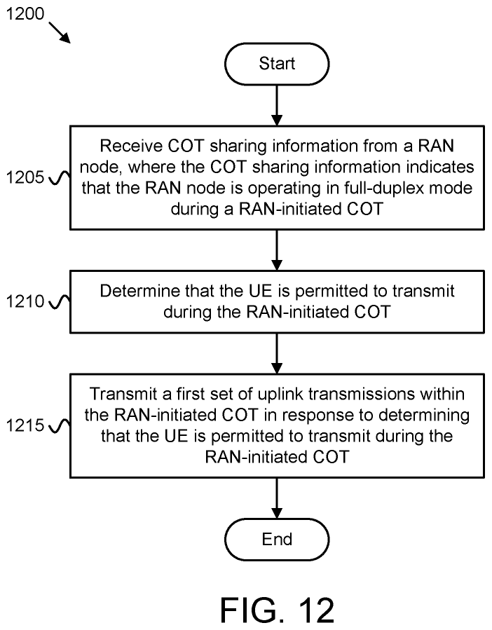

FIG. 12 depicts one embodiment of a method 1200 for full duplex operation in unlicensed spectrum, according to embodiments of the disclosure. In various embodiments, the method 1200 is performed by a UE device, such as the remote unit 105, the UE 205, and/or the user equipment apparatus 900, described above as described above. In some embodiments, the method 1200 is performed by a processor, such as a microcontroller, a microprocessor, a CPU, a GPU, an auxiliary processing unit, a FPGA, or the like.

The method 1200 begins and receives 1205 COT sharing information from a RAN node, where the COT sharing information indicates that the RAN node is operating in full-duplex mode during a RAN-initiated COT. The method 1200 includes determining 1210 that the UE is permitted to transmit during the RAN-initiated COT. The method 1200 includes transmitting 1215 a first set of uplink transmissions within the RAN-initiated COT in response to determining that the UE is permitted to transmit during the RAN-initiated COT. The method 1200 ends.

Disclosed herein is a first apparatus for full duplex operation in unlicensed spectrum, according to embodiments of the disclosure. The first apparatus may be implemented by a RAN node, such as the base unit 121, the RAN node 207, and/or the network apparatus 1000, described above. The first apparatus includes a processor and a transceiver that receives an UCI from a first UE, the UCI containing first COT sharing information and second COT sharing information, where the first COT sharing information includes a first duration and a first offset from the end of a slot where the UCI is detected, where the second COT sharing information includes a second duration, and where the first duration and the second durations are different. The processor that controls the transceiver to transmit a first set of DL transmissions to a first set of UEs for the duration of the first duration and transmit a second set of DL transmissions to a second set of UEs for the duration of the second duration, where the first set of DL transmissions occurs after the first offset and where the first UE belongs to the first set of UEs.

In various embodiments, the RAN node is capable of full-duplex operation. In some embodiments, the processor further controls the transceiver to transmit the second DL transmissions while concurrently receiving UL transmissions from the first UE. In some embodiments, the RAN node is permitted to transmit the second DL transmission after the last symbol of the UCI.

In some embodiments, the second COT sharing information further includes a second offset from the end of the slot where the UCI is detected, where the RAN node is permitted to transmit the second DL transmission after the second offset. In certain embodiments, the second offset is equal to the first offset, where the first set of DL transmissions and the second set of DL transmissions do not overlap in time. In certain embodiments, the first offset and the second offset are defined from the last symbol of the UCI.

In some embodiments, the first UE is capable of adapting communication to facilitate full duplex operation by the RAN node. In such embodiments, the processor configures the first UE to send the first COT sharing information and the second COT sharing information in the UCI.

In some embodiments, the processor further determines whether the medium is occupied at most by the first UE and controls the transceiver to transmit to a second UE in response to determining the medium is occupied at most by the first UE. In such embodiments, the RAN node simultaneously receives an UL transmission from the first UE while transmitting a DL transmission to the second UE. In certain embodiments, determining if the medium is occupied at most by the first UE includes determining a first received power/energy associated with the UL transmission of the first and determining whether the detected energy during an LBT period is not more than an offset with respect to the first received power/energy.

Disclosed herein is a first method for full duplex operation in unlicensed spectrum, according to embodiments of the disclosure. The first method may be performed by a RAN node, such as the base unit 121, the RAN node 207, and/or the network apparatus 1000, described above. The first method includes receiving an UCI from a first UE, the UCI containing first COT sharing information and second COT sharing information, where the first COT sharing information includes a first duration and a first offset from the end of a slot where the UCI is detected, where the second COT sharing information includes a second duration, and where the first duration and the second durations are different. The first method includes transmitting a first set of DL transmissions to a first set of UEs for the duration of the first duration and transmitting a second set of DL transmissions to a second set of UEs for the duration of the second duration. Here, the first UE belongs to the first set of UEs, and the first set of DL transmissions occurs after the first offset.

In various embodiments, the RAN node is capable of full-duplex operation. In some embodiments, the first method further includes transmitting the second DL transmissions while concurrently receiving UL transmissions from the first UE. In some embodiments, the RAN node is permitted to transmit the second DL transmission after the last symbol of the UCI.

In some embodiments, the second COT sharing information further comprises a second offset from the end of the slot where the UCI is detected, where the RAN node is permitted to transmit the second DL transmission after the second offset. In certain embodiments, the second offset is equal to the first offset, where the first set of DL transmissions and the second set of DL transmissions do not overlap in time. In certain embodiments, the first offset and the second offset are defined from the last symbol of the UCI.

In some embodiments, the first UE is capable of adapting communication to facilitate full duplex operation by the RAN node. In such embodiments, the RAN node configures the first UE to send the first COT sharing information and the second COT sharing information in the UCI.

In some embodiments, the first method further includes determining if the medium is occupied at most by the first UE and transmitting to a second UE in response to determining the medium is occupied at most by the first UE. In such embodiments, the RAN node simultaneously receives an uplink transmission from the first UE while transmitting a DL transmission to the second UE. In certain embodiments, determining if the medium is occupied at most by the first UE includes determining a first received power/energy associated with the UL transmission of the first UE and determining whether the detected energy during an LBT period is not more than an offset with respect to the first received power/energy.

Disclosed herein is a second apparatus for full duplex operation in unlicensed spectrum, according to embodiments of the disclosure. The second apparatus may be implemented by a UE device, such as the remote unit 105, the UE 205, and/or the user equipment apparatus 900, described above. The second apparatus includes a receiver that receives COT sharing information from a RAN node, where the COT sharing information indicates that the RAN node is operating in full-duplex mode during a RAN-initiated COT. The second apparatus includes a processor that determines that the apparatus is permitted to transmit during the RAN-initiated COT. The processor includes a transmitter that transmits a first set of uplink transmissions within the RAN-initiated COT in response to determining that the UE is permitted to transmit during the RAN-initiated COT.

In some embodiments, the COT sharing information includes a slot format indicator. In such embodiments, determining that the second apparatus is permitted to transmit during the RAN-initiated COT comprises identifying that uplink transmission is allowed in the RAN-initiated COT based on the slot format indicator. In some embodiments, determining that the second apparatus is permitted to transmit during the RAN-initiated COT includes receiving a bitmap in broadcast signaling, said bitmap indicating that the COT is a full duplex, RAN-initiated COT.

In some embodiments, the COT sharing information includes a set of feasible beams for sharing a full duplex, RAN-initiated COT. In such embodiments, transmitting the first set of uplink transmissions includes transmitting on at least one beam from the set of feasible beams. In some embodiments, the COT sharing information further indicates a first duration during which the RAN node transmits downlink transmissions. In such embodiments, transmitting the first set of uplink transmissions includes transmitting without performing a listen-before talk procedure when the first set of uplink transmissions is transmitted within the first duration.

Disclosed herein is a second method for full duplex operation in unlicensed spectrum, according to embodiments of the disclosure. The second method may be performed by a UE device, such as the remote unit 105, the UE 205, and/or the user equipment apparatus 900, described above. The second method includes receiving COT sharing information from a RAN node, where the COT sharing information indicates that the RAN node is operating in full-duplex mode during a RAN-initiated COT. The first method includes determining that the UE is permitted to transmit during the RAN-initiated COT and transmitting a first set of uplink transmissions within the RAN-initiated COT in response to determining that the UE is permitted to transmit during the RAN-initiated COT.

In some embodiments, the COT sharing information includes a slot format indicator. In such embodiments, determining that the UE is permitted to transmit during the RAN-initiated COT comprises identifying that uplink transmission is allowed in the RAN-initiated COT based on the slot format indicator. In some embodiments, determining that the UE is permitted to transmit during the RAN-initiated COT includes receiving a bitmap in broadcast signaling, said bitmap indicating that the COT is a full duplex, RAN-initiated COT.

In some embodiments, the COT sharing information includes a set of feasible beams for sharing a full duplex, RAN-initiated COT. In such embodiments, transmitting the first set of uplink transmissions includes transmitting on at least one beam from the set of feasible beams. In some embodiments, the COT sharing information further indicates a first duration during which the RAN node transmits downlink transmissions. In such embodiments, transmitting the first set of uplink transmissions includes transmitting without performing a listen-before talk procedure when the first set of uplink transmissions is transmitted within the first duration.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of a Radio Access Network (“RAN”) node [e.g., gNB], the method comprising:
receiving an Uplink Control Information (“UCI”) from a first User Equipment (“UE”), the UCI containing first Channel Occupancy Time (“COT”) sharing information and second COT sharing information:
wherein the first COT sharing information comprises a first duration and a first offset from an end of a slot where the UCI is detected, and
wherein the second COT sharing information comprises a second duration, and
wherein the first duration and the second duration are different;
transmitting a first set of downlink (“DL”) transmissions to at least one first UE belonging to a first set of UEs for the duration of the first duration, wherein the first set of DL transmissions occurs after the first offset; and
transmitting a second set of DL transmissions to at least one second UE belonging to a second set of UEs for the duration of the second duration, wherein the first UE belongs to the first set of UEs.

2. The method of claim 1, further comprising transmitting the second DL transmissions while concurrently receiving uplink (“UL”) transmissions from the first UE.

3. The method of claim 1, wherein the RAN node is permitted to transmit the second DL transmission after the last symbol of the UCI.

4. The method of claim 1, wherein the second COT sharing information further comprises a second offset from the end of the slot where the UCI is detected, wherein the RAN node is permitted to transmit the second DL transmission after the second offset.

5. The method of claim 4, wherein the second offset is equal to the first offset, wherein the first set of DL transmissions and the second set of DL transmissions do not overlap in time.

6. The method of claim 4, wherein the first offset and the second offset are defined from the last symbol of the UCI.

7. The method of claim 1, further comprising:
determining if the medium is occupied at most by the first UE; and
transmitting to a second UE in response to determining the medium is occupied at most by the first UE,
wherein the RAN node simultaneously receives an uplink transmission from the first UE while transmitting a DL transmission to the second UE.

8. The method of claim 7, wherein determining if the medium is occupied at most by the first UE comprises:
determining a first received power/energy associated with the uplink transmission from the first UE; and
determining if an amount of power/energy detected during a Listen-Before-Talk (“LBT”) period is not more than an offset with respect to the first received power/energy.

9. A Radio Access Network (“RAN”) apparatus, the apparatus comprising:
a transceiver receives an Uplink Control Information (“UCI”) from a first User Equipment (“UE”), the UCI containing first Channel Occupancy Time (“COT”) sharing information and second COT sharing information:
wherein the first COT sharing information comprises a first duration and a first offset from an end of a slot where the UCI is detected,
wherein the second COT sharing information comprises a second duration, and
wherein the first duration and the second duration are different; and
a processor that controls the transceiver to:
transmit a first set of downlink (“DL”) transmissions to at least one first UE belonging to a first set of UEs for the duration of the first duration, wherein the first set of DL transmissions occurs after the first offset; and
transmit a second set of DL transmissions to at least one second UE belonging to a second set of UEs for the duration of the second duration, wherein the first UE belongs to the first set of UEs.

10. A method at a User Equipment (“UE”), the method comprising:
receiving Channel Occupancy Time (“COT”) sharing information from a Radio Access Network (“RAN”) node, wherein the COT sharing information indicates that the RAN node is operating in full-duplex mode during a RAN-initiated COT;
determining that the UE is permitted to transmit during the RAN-initiated COT; and
transmitting a first set of uplink transmissions within the RAN-initiated COT in response to determining that the UE is permitted to transmit during the RAN-initiated COT.

11. The method of claim 10, wherein the COT sharing information comprises a slot format indicator, wherein determining that the UE is permitted to transmit during the RAN-initiated COT comprises identifying that uplink transmission is allowed in the RAN-initiated COT based on the slot format indicator.

12. The method of claim 10, wherein determining that the UE is permitted to transmit during the RAN-initiated COT comprises receiving a bitmap in broadcast signaling, said bitmap indicating that the COT is a full duplex, RAN-initiated COT.

13. The method of claim 10, wherein the COT sharing information comprises a set of feasible beams for sharing a full duplex, RAN-initiated COT, wherein transmitting the first set of uplink transmissions comprises transmitting on at least one beam from the set of feasible beams.

14. The method of claim 10, wherein the COT sharing information further indicates a first duration during which the RAN node transmits downlink transmissions, wherein transmitting the first set of uplink transmissions comprises transmitting without performing a listen-before talk procedure when the first set of uplink transmissions is transmitted within the first duration.
